(19) United States
(12) Patent Application Publication
(10) Pub. No.: US 2014/0363794 A1
(43) Pub. Date: Dec. 11, 2014

(54) Diabetic Patients Compliance and Outcomes by Publicizing that Increased Compliance Improves Blood Glucose Control and Outcomes

(71) Applicant: EosHealth, Inc., Houston, TX (US)

(72) Inventor: Kimon J. Angelides, Houston, TX (US)

(21) Appl. No.: 14/474,172

(22) Filed: Aug. 31, 2014

Related U.S. Application Data
(63) Continuation-in-part of application No. 13/705,341, filed on Dec. 5, 2012.
Application No. 13/705,341 is a continuation-in-part of application No. 13/656,692, filed on Oct. 20, 2012.
Application No. 13/656,692 is a continuation of application No. 13/485,849, filed on May 31, 2012, now Pat. No. 8,812,244.
Application No. 13/485,849 is a continuation-in-part of application No. 12/693,849, filed on Jan. 26, 2010.
(60) Provisional application No. 61/147,157, filed on Jan. 26, 2009.

(51) Int. Cl. G09B 5/02; G09B 19/00

(52) U.S. Cl. CPC G09B 5/02; G09B 19/0092
USPC 434/127

(57) ABSTRACT

Improved outcomes of patients resulting from: continuous monitoring of blood glucose level, other metabolites, food consumption, and preferably, exertion level; and resulting from providing personalized education and other advice on insulin and drug administration, food consumption and timing, and exercise type and intensity, as well as reward test strips which entitle the patient to a discount, rebate or other benefit, are publicized to increase patient compliance with the recommended diet, exercise, and/or testing, drug administration, and improve patient clinical outcomes; or are publicized to recruit new patients into the system, and thereby improve the outcomes and overall health of an increasing proportion of the diabetic patient population. The improved blood glucose level control or other measurable parameters that follow from increased patient compliance and the use of reward test strips can also be publicized to improve patient compliance or recruit more patient into the system.

### RELATED APPLICATIONS

This application is a CIP of and claims priority to U.S. application Ser. No. 13/705,341, filed Dec. 5, 2012, which is a CIP of and claims priority to U.S. application Ser. No. 13/656,692, filed Oct. 20, 2012, which is a CIP of claims priority to U.S. application Ser. No. 13/485,849, filed May 31, 2012, which is a CIP of claims priority to U.S. application Ser. No. 12/693,849, filed Jan. 26, 2010, which is a nonprovisional of and claims priority to U.S. Provisional No. 61/147157, filed Jan. 26, 2009. All these applications are incorporated by reference.

### BACKGROUND

As America's fifth-deadliest disease, and as there are over 20 million American diabetics, diabetes mellitus places a particularly high expense burden on the public healthcare system. Millions of Americans are not even aware that they have the disease, and an additional 50 million plus Americans have pre-diabetes. If the present trends continues, 1 in 3 Americans, including as many as 1 in 2 minorities born in 2000 will develop diabetes during their lifetime.

Diabetes is a group of chronic metabolic diseases marked by high levels of blood glucose resulting from defects in insulin production, insulin action, or both. While diabetes can lead to serious complications and premature death, effective treatment requires the diabetic patient to take steps to control the disease and lower the risk of complications.

About 5-10% of diabetics have Type 1 diabetes, while 90-95% have Type 2 diabetes. Type 1 is an autoimmune disease while Type 2 results from insulin resistance or inadequate insulin production. Type 1 has clear genetic markers while Type 2 is genetically heterogeneous and therefore has a broader and less certain origin. About 80% of Type 2 diabetics are overweight.

Since 1987, the death rate due to diabetes has increased by 45 percent, while the death rates due to heart disease, stroke, and cancer have declined, emphasizing both the failures of the current treatment approaches as well as the rapid growth of this disease.

Uncontrolled diabetes leads to chronic end-stage organ disease and in the United States is a leading cause of end-stage renal disease, blindness, non-traumatic amputation, and cardiovascular disease. It is also associated with complications such as:
Heart Disease and Stroke (#1 cause of death for diabetics and 2-4 time higher than the general population)
High Blood Pressure (3 in 4 diabetics)
Nervous System Damage (can lead to amputations and carpel tunnel syndrome)
Pregnancy Complications (including gestational diabetes)
Sexual Dysfunction (double the incidence of erectile dysfunction)
Periodontal Disease

In the USA, over 85% of people aged 65 and over have diabetes, a fact that complicates their total health picture and often accelerates chronic end-stage disease, adding an enormous strain to the healthcare system. Prevalence is highest among minorities and increases in all groups with age and obesity. In addition, there are correlations of higher diabetes incidence with smokers, and Alzheimer's patients.

Poor control of blood-glucose in diabetes dramatically increases the risk of heart disease, stroke, amputations, blindness, renal disease and failure, impotence, and many other diseases—better control of blood-glucose levels greatly mitigates these complications. Coupled with proper education, nutrition, maintenance of stable blood-glucose levels, and regular exercise, many Type 1 and 2 diabetics can minimize the effects of the disease.

With the growing problem of diabetes in developed and developing countries comes a growing need for convenient blood glucose monitoring, and convenient methods for analysis and treatment based on the monitoring. Diabetes patients need to monitor their blood glucose multiple times a day and record this information, which is analyzed, along with other parameters such as quantity of exercise and their diet, and then use the results to determine food intake, adjust the dosage of insulin and/or other therapeutic agent, and to recommended exercise intensity or cessation. Compliance with the monitoring, diet and exercise regimes is a challenge due to their complexity and temptation to avoid the recommended diet, which is low in simple sugars, and the recommended exercise regime.

U.S. application Ser. No. 13/656,692 describes a personalized system of education, monitoring and advising on glucose testing, diet, exercise and drug administration, which is based on patient preferences and data continuously input by the patient. The patient preferences, particularly for food, meal timing and exercise are input initially and then frequently updated. Educational messages are provided to the patients in the program based on blood glucose level, levels of other metabolites, time and content of last meal, exertion level, and other factors.

Initial results and patient responses indicate that the personalized system described in U.S. application Ser. No. 13/656,692, or similar personalized systems of monitoring, education and providing personalized feed-back, are effective in increasing compliance. Publicizing the increased compliance from such personalized systems allows recruiting of more patients into the system, to thereby improve clinical outcomes for an increasing patient population.

### SUMMARY

In the invention, the improved outcomes of patients resulting from: continuous monitoring of blood glucose level, of other metabolites, of food consumption, and preferably, of exertion level; and from providing personalized education and other advice on insulin and drug administration, food consumption and timing, and exercise type and intensity—are publicized to increase patient compliance with the recommended diet, exercise, and/or testing, drug administration, and improve patient clinical outcomes; or are publicized to recruit new patients into the system, and thereby improve the outcomes and overall health of an increasing proportion of the diabetic patient population. The improved blood glucose level control or other measurable parameters that follow from increased patient compliance can also be publicized to improve patient compliance or recruit more patient into the system.

Integrated with the foregoing methods of improving compliance is a reward system for users to provide additional incentives to continue using the system, and to provide incentives for recruiting new patients into the system. The reward system preferably employs encoded strips with a unique identifier or other encoding. This identifier can be: (i) read and decoded when the strip is inserted into the glucometer for blood glucose testing, or (ii) can be ostensible encoding which the user can readily see or otherwise decode, e.g., color, or (iii) the strip can have both a unique identifier decoded by a glucometer and ostensible encoding. In the preferred reward system, certain encoded strips entitle the user to a reward, rebate or other incentive.

Where the strips include a unique machine-readable identifier, the strips can track strip consumption, trigger particular messages to the user, or aid in tracking user compliance with the testing regime. Where the strip consumption is tracked, the results can be used to verify that consumption by the user matches with predicted consumption, which is based on the user testing at least a certain number of times each day. If consumption is below the predicted level, the user can be prompted to test more often, and thus maintain compliance. The results of strip consumption can also be tracked across all the users of the system, and used to verify that strip production and available supply can meet demand. In all cases, the strip rewards incentivizes patients to use strips at close to the anticipated frequency so that anticipated demand is more predictable, and so that supply and availability can be more accurately predicted, which reduces production and distribution costs for the strips.

The steps in the process of the invention can be depicted in summary form as follows:

A PERSONALIZED SYSTEM including continuous monitoring, and providing personalized education relating to health risks associated with patient information received and patient preferences; as well as providing specific queries and recommendations relating to insulin and drug administration, food consumption and timing, and exercise type and intensity , where patient interactions with the SYSTEM are through the web, a wireless or GPRS link, in person, or through a web-based link on a cell phone, phone, or computer, and where the following steps are carried out:

PATIENT INPUT of preferences for food type and consumption schedule and food exclusions (including due to allergies, strong negative preference or other contra-indications); exercise type, intensity and schedule; and exercise exclusions or limitations (due to physical limitations or otherwise);

MONITOR patient for relevant blood glucose and other metabolite levels (CLINICAL PARAMETERS), and for feelings and symptoms particularly those relating to diabetic risks (particularly related to blood glucose level) and other symptoms, and food recently consumed and exercise level, and optionally, all other patient feelings and symptoms (REPORTED PARAMETERS);

TESTING for CLINICAL PARAMETERS by analyzing a blood sample;

ENTER and UPDATE for each patient: CLINICAL PARAMETERS and REPORTED PARAMETERS, including health care worker notes and patient preferences, on Charts;

STORE Charts such that only specified access is allowed;

PERFORM statistical analysis of CLINICAL PARAMETERS and CLINICAL OUTCOMES to determine, preferably to a specified statistical significance, whether the PERSONALIZED SYSTEM is effective in providing improved CLINICAL OUTCOMES and improving control of CLINICAL PARAMETERS;

DISCLOSE the improved CLINICAL PARAMETERS and CLINICAL OUTCOMES (preferably, those which reach statistical significance for an individual in the SYSTEM or for a population in the SYSTEM) to increase compliance of patients in the SYSTEM with the testing, reporting, diet and exercise regimen; and/or

PUBLICIZE the improved CLINICAL PARAMETERS and better controlled CLINICAL OUTCOMES (preferably, those which reach statistical significance) to recruit new subjects for the SYSTEM;

INCENTIVIZE the patients in the SYSTEM to continue in the SYSTEM and comply with its recommendations using rewards, which are based on the patient receiving an encoded strip;

INTEGRATE the new subjects into the SYSTEM to improve their CLINICAL OUTCOMES or improve control of their CLINICAL PARAMETERS, and INCENTIVIZE the new patients to continue in the SYSTEM and comply with its recommendations using rewards.

Further details and exemplification of the SYSTEM is set forth below.

### DETAILED DESCRIPTION

It is well-known that control of diabetes is dependent on controlling CLINICAL PARAMETERS (blood glucose level primarily, and other metabolites, including ketones, LDL and cholesterol, secondarily). CLINICAL OUTCOMES, including survival, cardiovascular disease, cataracts, non-healing wounds, tissue necrosis and amputation are improved where there is better control of CLINICAL PARAMETERS. The control of CLINICAL PARAMETERS is related to the interaction between diet, exercise and administration of insulin and other drugs, which all need to be controlled. The control of CLINICAL PARAMETERS requires continuous monitoring of CLINICAL PARAMETERS. It is difficult for patients to determine the proper balance of diet, exercise and insulin/drug administration to best control blood glucose level, and then follow the same regimen over the course of days and weeks. Moreover, the temptation to avoid recommended exercise or seek foods that are higher in simple sugars or otherwise contra-indicated can be overwhelming, especially without proper incentives and support.

A solution to these issues is the systems set forth in the priority applications (Ser. Nos. 13/656,692; 13/485,849; 12/693,849) where patient preferences, particularly for diet and exercise, are input and then continuously updated, and suggestions for similar foods, and similar exercise regimens, or ceasing exercise, are made. In these systems, the patient's blood glucose level and other monitored information is sent to a server for centralized monitoring and recording. Preferably, the levels and the information are sent over a wireless link, e.g., the cellular GPRS-communication linked glucometer-pedometer, described in U.S. Pat. No. 8,066,640 (incorporated by reference), and are preferably also recorded on the portable glucometer device carried by the patient.

Ser. No. 13/656,692 discusses sub-icons displayed upon actuating the “Trends” icon on the patient's device, where this icon indicates, on a constantly updated basis, the results of blood glucose and other metabolites over time, number of times blood glucose or other metabolites fall below a threshold or otherwise outside a particular range, results before and after meals, patterns over time periods, and other analysis useful to the patient and the health care team.

In the preferred SYSTEM, the patient would initially enter a number of food and exercise preferences and limitations (like food exclusions due to, e.g., allergies or physical limitations, if applicable) at initiation. Depending on the blood glucose level, ketone (and other metabolite) levels, exertion level, time and content of last meal, patient feelings, and last insulin administration, the patient is provided recommendations for food consumption, continuation or cessation of exercise, insulin administration; and the patient can also be provided emergency notifications like “stop driving” or “eat immediately,” or “stop exercising.” The patient is also provided educational messages related to the monitored information received and the recorded preferences, relating to, for example, the particular health risks associated with high blood glucose levels. These messages and the ability of the system to account for patient preferences and limitations in making recommendations, help to motivate the patient to adhere to the diet, exercise and testing regime, and thereby improve CLINICAL OUTCOMES for patients in the SYSTEM .

The incentive for the user to use the SYSTEM is enhanced by using a reward system based on encoded strips, wherein certain encoded strips provide rewards (such as discounts, rebates or additional free strips), and preferably, wherein the encoded strips associated with the reward for the user (“Reward Strips”) are ostensibly differentiated, e.g., by color. The Reward Strips are also preferably encoded with another identifier (which is read and decoded automatically), to help track strip consumption, to provide messages to the user, or aid in tracking user compliance with the testing regime. Where the strip consumption is tracked, the results can be used to verify that consumption by the user matches with predicted consumption, which is based on the user testing at least a certain number of times each day. If consumption is below the predicted level, the user can be prompted to test more often. The results of strip consumption can also be tracked across all the users of the system, and used to verify that strip production and available supply can meet demand. In all cases, the strip rewards incentivizes patients to use strips at close to the anticipated frequency so that anticipated demand is more predictable, and so that supply and availability can be more accurately predicted, which reduces production and distribution costs for the strips.

The identifier on the Reward Strips which is automatically decoded is preferably part of an imprinted electronic circuit of the strip, in a layer of the strip. The Reward Strips also preferably include imprinted electronic circuits that, once inserted into the glucometer, aid it in performing an autocorrection function, to correct for batch to batch differences in the functional (blood glucose reading) parts of the Reward Strips. Following the autocorrection function, the glucometer will apply a correction factor to the blood glucose reading associated with the strip. This ensures consistent readings from strip batch to batch. In connection with the autocorrection, the glucometer decodes the identifier in the Reward Strip as well.

To help improve control of CLINICAL PARAMETERS and CLINICAL OUTCOMES for a broader patient population, the improved control of CLINICAL PARAMETERS and the improved CLINICAL OUTCOMES from patients already in the SYSTEM can be publicized so that a wider population of diabetics is made aware of the improved CLINICAL OUTCOMES related to the SYSTEM. The improvements in control of CLINICAL PARAMETERS and improvements in CLINICAL OUTCOMES which are reported are preferably those which can be shown with statistical significance. The use of Reward Strips is also publicized, along with how they help in improving compliance, CLINICAL PARAMETERS and CLINICAL OUTCOMES.

As more patients enter the SYSTEM, their results (CLINICAL PARAMETERS and improvements in CLINICAL OUTCOMES) are also entered, tracked and analyzed. The data analysis can be segmented further as the patient population increases. The segmenting can include analysis of correlations between the variance of only one or several CLINICAL PARAMETERS and the effect on CLINICAL OUTCOMES. For example, one can correlate the frequency with which blood glucose exceeds a specified level with the incidence of particular adverse CLINICAL OUTCOMES (preferably, with statistical significance). Or, one can correlate the frequency with which both blood glucose levels and ketone levels exceed a specified level with the incidence of particular adverse CLINICAL OUTCOMES (preferably, with statistical significance). Segmenting also allows one to correlate the effect that Reward Strips have on CLINICAL PARAMETERS and CLINICAL OUTCOMES. Patient populations can be divided into those that use Reward Strips and those that don't, and CLINICAL PARAMETERS and CLINICAL OUTCOMES of each sub-population can then be compared.

Also, as the data available for each patient in the SYSTEM increases, correlations between the variance in CLINICAL PARAMETERS and the effect on CLINICAL OUTCOMES can be individualized. For example, the correlations between frequency of incidence of high blood glucose level and slow wound healing can be correlated for individuals in the SYSTEM. Again, the correlations are preferably analyzed to statistical significance (p value≦0.05). In this way, individuals can be aware of their propensities for adverse CLINICAL OUTCOMES, and whether the frequency of monitoring of CLINICAL PARAMETERS should be increased, or whether diet, exercise, insulin or other drug administration should be modified or more frequently monitored. Individuals with greater propensity for adverse CLINICAL OUTCOMES, and/or a known pattern of out of range CLINICAL PARAMETERS, could be incentivized differently with Reward Strips than others. For example, such individuals could be given greater rewards, or more frequent rewards, when their testing is at the recommended frequency and/or their CLINICAL PARAMETERS stay in range. This can be accomplished using the strip encoding identifiers, i.e., such individual's strips can be tracked by central monitoring and then the greater or more frequent rewards can be triggered from the central monitoring station. Rewards can also be increased to certain users for other reasons, for example, additional incentives can be provided by the Reward Strips if the user recommends additional customers, agrees to use of their information in advertising, or agrees to appear in advertising themselves.

The data tracking for each patient could also compare incidence of CLINICAL OUTCOMES which occurred over a particular period where there was less strict compliance with the recommended diet, exercise or testing regimen, with those where there was more strict compliance. The comparison could be, for example, of the CLINICAL OUTCOMES before the patient entered the SYSTEM as against incidence of the same CLINICAL OUTCOMES after the patient entered the SYSTEM, or of the CLINICAL OUTCOMES where the patient did not use Reward Strips as against incidence of the same CLINICAL OUTCOMES after the patient used Reward Strips, or of CLINICAL OUTCOMES during a period when CLINICAL PARAMETERS varied widely from recommended level compared to a period where the CLINICAL PARAMETERS remained more in range. One such CLINICAL OUTCOME which may be readily tracked is frequency of slow healing wounds, especially if there are records of physician visits to treat such wounds from before the patient entered the SYSTEM. These records can be compared to clinical records showing frequency of wound healing after the patient entered the SYSTEM. Again, the results can be statistically analyzed to determine the statistical significance (p value) of the correlation between the patient using the SYSTEM (or using the SYSTEM but with Reward Strips) and decreased incidence of slow-healing wounds. In this analysis, slow-healing wounds can be defined as those which fail to heal within a specified time. Again, such patients with a particular health issue, like slow healing wounds, can be tracked centrally and their Reward Strips can be triggered to provide them additional incentive to keep CLINICAL PARAMETERS in range.

While it is preferable that CLINICAL PARAMETERS are automatically reported and recorded (see U.S. application Ser. No. 13/656,692) following patient testing, the patients in the SYSTEM are also preferably sent frequent inquiries requiring their response and reporting, including information about food consumption, exercise and their feelings and symptoms which indicate CLINICAL PARAMETERS may be out of the desired range. These inquiries can also be incentivized using the Reward Strips, so that, e.g., responding by testing (where recommended) garners a reward, or in a related manner, maintaining CLINICAL PARAMETERS within specified ranges over a specified period garners a reward.

A further level of analysis is to determine the correlation between patient reporting compliance and CLINICAL OUTCOMES; i.e., determine whether subjects with significant lapses in reporting frequency suffer increased incidents of adverse CLINICAL OUTCOMES. Again, if it is demonstrated with statistical significance that increased reporting compliance improves CLINICAL OUTCOMES, this correlation could be publicized to increase reporting compliance of patients in the SYSTEM, and to draw more patients into the SYSTEM. The Reward Strips and the incentives they provide, as well as any increased positive effects on CLINICAL OUTCOMES when Reward Strips are used in the SYSTEM, could be concurrently publicized to make it even more attractive for new patients to join the SYSTEM. And, if it is demonstrated with statistical significance that providing Reward Strips increased reporting compliance an/or improves CLINICAL OUTCOMES, this could also be publicized to attract patients into the SYSTEM.

A further level of analysis which can be done as the patient population in the SYSTEM increases is to determine the likelihood of effect on CLINICAL OUTCOMES from particular events; e.g., blood glucose (BG) out of range, or the number of times BG past a threshold which indicates it is significantly out of range; ketone level out of range, or the number of times ketone level past a threshold indicating it is significantly out of range; contra-indicated foods consumed, high patient obesity level, failure to perform recommended exercise for a particular period, or exceeding recommended exertion level for a particular period. The likelihood can be determined using the Cox proportional hazards model where these events are explanatory covariates and the baseline covariates include patient age, weight, and others.

With the same analysis (Cox proportional hazards model) one can also determine the likelihood of effect on CLINICAL PARAMETERS, particularly, blood glucose level or ketone level, from diet and exercise events. For example, one can determine the likelihood that eating a quantity of candy will move blood glucose past a threshold. Moreover, the likelihood that the frequency of one or more of the foregoing events declines when Reward Strips are used in the SYSTEM can also be statistically analyzed using the Cox proportional hazards model or other formulation. The likelihood of decline in such frequency can also be correlated with the likelihood of improved CLINICAL OUTCOMES when Reward Strips are in the SYSTEM.

The determination of likelihood of effect on CLINICAL OUTCOMES from particular events or on CLINICAL PARAMETERS from diet or exercise events, is described above as based on the patients in the SYSTEM and therefore applying to the entire SYSTEM patient population. But, as data about an individual in the SYSTEM accumulates, the likelihood of effect on his/her CLINICAL PARAMETERS from diet or exercise events can be determined on an individual basis. That is, the individual can be provided the likelihood that eating a particular quantity of candy will move his/her blood glucose past a threshold, based on analysis of that individuals' records. Similarly, the likelihood of the positive effect of continuing to use Reward Strips can be determined on an individual basis, as data about an individual in the SYSTEM using Reward Strips accumulates.

The likelihood of the effect on CLINICAL OUTCOMES from particular events or the effect on CLINICAL OUTCOMES or CLINICAL PARAMETERS from diet or exercise events, or from overall increased or decreased compliance with the recommended diet and exercise regime, is intended for use in patient education to improve their CLINICAL OUTCOMES through increasing compliance. With the real-time patient/server interaction with the SYSTEM, the patient can be provided educational messages about the level of risk from particular events or from diet or exercise events. For example, if patient blood glucose or ketone level tests at above a threshold, the patient can be advised (from the server, preferably) of the likelihood of particular CLINICAL OUTCOMES for the patient population. Similarly, the patient can be advised of the individualized risk that his blood glucose will surpass a desirable level if he eats a quantity of candy (preferably in response to a patient query on that question). The educational messages can further include messages related to rewards for patients. For example, patients could lose rewards for eating candy or not exercising as recommended, or have to test additional times with Reward Strips to get to the same rewards level with such events. Again, the capability in the SYSTEM to provide likelihood of effect on CLINICAL OUTCOMES from particular events or on CLINICAL PARAMETERS from diet or exercise events can be publicized as a tool to recruit additional patients into the SYSTEM, and thereby expand the pool of patients having increased compliance to their treatment regimes.

In addition to analyzing CLINICAL PARAMETERS and diet and exercise events for correlation with CLINICAL OUTCOMES, it is also possible to correlate the capability the SYSTEM provides for more frequent monitoring and interactive advice and educational messages, and optionally use of Reward Strips as well, with patient compliance with the testing, drug administration, diet and exercise regime. That is, as a patient enters the SYSTEM his/her compliance can be monitored and analyzed to indicate what the compliance typically was prior to entering the SYSTEM, or what it is over a particular period after entering the SYSTEM, and also whether using the SYSTEM over time increases compliance, and also whether using the SYSTEM with Reward Strips over time increases compliance. It can be determined if compliance with different aspects of the treatment regimen increases, decreases or remains stable as the patient interacts with the SYSTEM, and/or uses Reward Strips. The compliance determination can also be expanded to determine if the entire SYSTEM population experiences increased compliance as time in the system increases. Again, assuming compliance increases, the increased compliance can be publicized as a tool to recruit additional patients into the SYSTEM, and thereby expand the pool of patients with increased compliance to their treatment regimes.

It is further noted that methods other than the Cox proportional hazards model (including other regression analysis and including Kaplan-Meier analysis of survival) could be used to determine the likelihood of effect on CLINICAL OUTCOMES from particular events or on CLINICAL PARAMETERS from diet or exercise events, or from use of Reward Strips. Other methods will occur to those of skill in the art and are incorporated herein.

It is noted above that the patient information in the SYSTEM is stored on Charts. This patient information includes blood glucose levels, blood chemistry, medical history and diagnoses, drug reactions, allergies, family medical history, lab reports, physicians notes and nurses notes. Charts may also include the patient preferences for food and exercise. Charts would also include the use of Reward Strips and providing rewards to the patient under the Reward Strips program.

The Charts are preferably stored in the server, which provides interaction with the patients in the SYSTEM. As the Charts contain private medical records, access to them needs to be controlled to protect patient privacy. However, it is preferred that the patient or the patient's physician can obtain access to the Charts from remote locations, and preferably the access is by the web, or by wireless or GPRS link but can also include atmospheric transmission, as well as transmission through sub-space or space; transmission through fiber-optic cable, superconductive materials, cable, telephone lines, or other links for data transmission. Access may be expanded to other health care workers so the Charts can be updated with other patient information, or access should also be allowed to emergency physicians in the event of a patient health crisis.

The Payor for the patient's healthcare (Medicare, Medicaid, or private insurance) should also be allowed access to particular information from the Charts so that the Payor can review costs/FTE, payments, risk groups, and diabetes medical metrics in determining reimbursement for patient health care costs. But the information the Payor needs is limited to things like number of tests performed by the patient, and costs of the SYSTEM, so the other information in the Charts need to be coded/redacted to maintain its confidentiality. Certain of this information may also be available in coded or redacted form to an auditor of the accounts for Payor or another party.

As described above, after patient data is compiled and CLINICAL OUTCOMES are analyzed, summaries of results are to be publicized to recruit additional patients into the SYSTEM. The summaries publicized can include individual improvements in an individual's CLINICAL OUTCOME (with and without Reward Strips); improvements in an individual's maintenance of CLINICAL PARAMETERS within a range (with and without Reward Strips); improvements in an individual's compliance with the recommended CLINICAL PARAMETER testing, drug administration, and diet and exercise regime; and improvements in reporting compliance and CLINICAL OUTCOMES (with and without Reward Strips). The summaries publicized can also be of the SYSTEM population's improvements in CLINICAL OUTCOMES; improvements in the SYSTEM population's maintenance of CLINICAL PARAMETERS within a range; improvements in the SYSTEM population's compliance with the recommended CLINICAL PARAMETER testing, drug administration, and diet and exercise regime; and improvements in the SYSTEM population's reporting compliance and their CLINICAL OUTCOMES (again, with and without Reward Strips for all such CLINICAL PARAMETERS and CLINICAL OUTCOMES).

Publicizing of such results and information can be by one or more of: publishing articles in scientific or medical journals; filing published patent applications; sending information about the results through electronic media (telephone solicitations, television, radio, or internet advertising) or through the mail or through direct contact with consumers. Publicizing also includes posting such results and information on a website, a billboard or other location accessible to consumers and medical professionals. Any publicizing of results that discusses the advantages, improved compliance, improved CLINICAL PARAMETERS or improved CLINICAL OUTCOMES experienced through using the SYSTEM would fall within the scope of publicizing results, as would any attempt to recruit patients into the SYSTEM based on such advantages or improvements.

The CLINICAL PARAMETERS are determined using diagnostic tests, for example, conventional blood glucose level testing using test strips and an electronic reader. However, CLINICAL PARAMETERS can include a number of marker determinations, including genetic markers or protein assays, gene expression levels, or other assays for any chemical, compound, nucleic acid, protein, organism, virus, prion or biological material, and including tests where there is an interaction involving a chemical change in the form of hybridization, adsorption, binding, bonding (including covalent, non-covalent, polar and Van der Waals) chelation, or another reaction or interaction involving transformation of matter. The diagnostic tests include those for nucleic acids which rely on fluorescence detection, radiation detection, or other chemical or biological indicators of interaction or transformation of matter.

The Reward Strips incentivize patients to use strips at close to the anticipated frequency so that anticipated demand is more predictable, and so that supply and availability can be more accurately predicted, which reduces production and distribution costs for the strips. For example, one could have a system of tailoring production or supply of strips which is based on providing Reward Strips. When overall strip consumption deviates below a specified level, the rewards associated with the Reward Strips could be increased, or proportionally more Reward Strips could be added into the strip supply, to incentivize consumption. Alternatively, if overall strip consumption exceeds a specified level, indicating production or distribution may be falling behind consumption, the rewards associated with the Reward Strips could be decreased, or proportionally fewer Reward Strips could be added into the strip supply. In either case, the way the Reward Strips are being adjusted would need to be publicized to the consumers. The precise adjustment to the Reward Strips in these cases could be performed by heuristic methods or the methods associated with pricing science, as a demand optimization problem, where the production of strips is limited.

The specific methods, processes and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. It will be readily apparent to one skilled in the art that varying substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential. Thus, for example, in each instance herein, in embodiments or examples of the present invention, any of the terms “comprising”, “including”, containing”, etc. are to be read expansively and without limitation. The methods and processes illustratively described herein suitably may be practiced in differing orders of steps, and that they are not necessarily restricted to the orders of steps indicated herein or in the claims. It is also noted that as used herein and in the appended claims, the singular forms “a,” “an,” and “the” include plural reference, and the plural include singular forms, unless the context clearly dictates otherwise. Under no circumstances may the patent be interpreted to be limited to the specific examples or embodiments or methods specifically disclosed herein. Under no circumstances may the patent be interpreted to be limited by any statement made by any Examiner or any other official or employee of the Patent and Trademark Office unless such statement is specifically and without qualification or reservation expressly adopted in a responsive writing by Applicants.

The invention has been described broadly and generically herein. Each of the narrower species and subgeneric groupings falling within the generic disclosure also form part of the invention.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

1. A process of increasing diabetic patients' compliance with a recommended diet regimen and publicizing the increased compliance to recruit additional patients, comprising:
providing a recommended diet and exercise regimen for the patients to follow for a particular forthcoming period;
providing an interactive link between a server and device(s) carried by each of the patients, wherein the device tests a blood sample from the patients for blood glucose level and the device sends the determination of said blood glucose level to the server, and wherein the device(s) or the server queries the patients about prior food consumption and time of food consumption, and where the server, analyzes the blood glucose level test results and query responses, and sends the patient advisory messages about future food consumption and timing of food consumption, and about timing of further testing;
monitoring whether patients' compliance with the recommended diet regimen increases or decreases compared to a prior period;
determining whether during the monitored period, the patients' clinical outcomes, including survival, cardiovascular disease, cataracts, non-healing wounds and amputation, and tissue necrosis, improves, compared to a prior period, when there is increased patient compliance with the recommended diet regimen during said monitored period, or whether one or more of the patients' clinical outcomes declines when there is decreased patient compliance with the recommended diet regimen during said monitored period;
notifying the patients that one or more of the patients' clinical outcomes improve when there is increased patient compliance with the recommended diet regimen, or that one or more of the patients' clinical outcomes declines when there is decreased patient compliance with the recommended diet regimen, in order to encourage compliance by the patients with the recommended diet regimen; and
publicizing that clinical outcomes or patient compliance is improved to recruit additional patients.

2. The process of claim 1 further including monitoring of the patients' exertion level and analyzing the exertion level by the server which sends the patient advisory messages about future exertion and timing of said future exertion.

3. The process of claim 2 further including advising the patients, from the server, to cease exertion or increase exertion based on patient preferences and limitations entered in the server, and one or more of: blood glucose level, time from last food intake, and time from last insulin or drug administration.

4. The process of claim 1 further including advising the patients, from the server, to eat, and what to eat, based on patient preferences and limitations as entered into the server, and one or more of: blood glucose level, time from last food intake, and time from last insulin or drug administration.

5. The process of claim 1 further including providing education to the patients, based on patient preferences and limitations as entered into the server, of risks involved with disregarding the recommended diet and exercise regimen, or with blood glucose or ketone levels outside of specified ranges.

6. The process of claim 5 wherein the education provided to the patients is also based on one or more of the patients': blood glucose level, time from last food intake, and time from last insulin or drug administration.

7. The process of claim 1 wherein the device also tests for ketone level, LDL and cholesterol.

8. A process of increasing diabetic patients' compliance with a recommended testing, diet and exercise regimen and publicizing the increased compliance to recruit additional patients, comprising:
providing a recommended testing, diet and exercise regimen for the patients to follow for a particular forthcoming period;
providing an interactive link between a server and device(s) carried by each of the patients, wherein the device tests a blood sample from the patients for blood glucose level and the device determines patient exertion level by measuring patient movement or acceleration, and the device sends the determinations of said blood glucose level and exertion level to the server, and where the device(s) or the server query the patients about prior food consumption and time of consumption, and where based on analysis of the blood glucose level test results, exertion level and query responses, the server sends the patients advisory recommendations about future food consumption and timing of food consumption, about timing of further testing, and about continuing or ceasing exertion;
determining whether blood glucose level is more likely to remain within a recommended range for a period for the patients who more strictly adhered to the testing, diet and exercise regimen recommendations;
notifying the patients that their blood glucose level remained or were more likely to remain within a recommended range when there was more strict patient compliance with the recommended testing, diet and exercise regimen, in order to improve compliance of the patients with the recommended testing, diet and exercise regimen; and
publicizing that blood glucose level control is improved to recruit additional patients.

9. The process of claim 8 further including advising the patients, from the server, to cease exertion or increase exertion based on patient preferences and limitations entered in the server, and one or more of: blood glucose level, time from last food intake, and time from last insulin or drug administration.

10. The process of claim 8 further including providing education to the patients, based on patient preferences and limitations of risks involved with disregarding the recommended diet and exercise regimen, or with blood glucose or ketone levels outside of specified ranges.

11. The process of claim 9 wherein the patient preferences and limitations are frequently updated.

12. The process of claim 8 wherein the device also tests for blood ketone level, LDL and cholesterol.

13. The process of claim 8 wherein in response to queries, the patients provide information including feelings, reactions to medications, exertion level, time from last food intake, and time from last drug administration.

14. The process of claim 8 wherein a health care worker intervenes or advises the patients if their blood glucose level, ketone level or other patient status indicators indicate the possibility of a patient adverse event.

15. The process of claim 1 wherein a health care worker intervenes or advises the patients if their blood glucose level, ketone level or other patient status indicators indicate the possibility of a patient adverse event.
